(19) United States
(12) Patent Application Publication
(10) Pub. No.: US 2022/0400447 A1
(43) Pub. Date: Dec. 15, 2022

(54) CELL SECTOR TRANSMISSION SYSTEM

(71) Applicant: RAKUTEN MOBILE, INC., Tokyo (JP)

(72) Inventors: Kang KANG, Tokyo (JP); Youngbin KIM, Tokyo (JP); Warangrat WIRIYA, Tokyo (JP); Ite LIN, Tokyo (JP); Bingxuan ZHAO, Tokyo (JP); Nobuyuki UCHIDA, Tokyo (JP)

(21) Appl. No.: 17/456,574

(22) Filed: Nov. 25, 2021

Related U.S. Application Data
(60) Provisional application No. 63/208,943, filed on Jun. 9, 2021.

(51) Int. Cl. H04W 52/24; H04W 52/22

(52) U.S. Cl. CPC H04W 52/244; H04W 52/223

(57) ABSTRACT

A method includes simulating, using processing circuitry, one or more sector antenna transmitting at a selected transmission power, each of the one or more sector antenna simulated as being located at a desired physical location. The method also includes determining, based on results of the simulation, a short-term interference and a long-term interference for each of the one or more sector antenna. The method also includes performing, by the processing circuitry and based on a short-term interference threshold and a long-term interference threshold for the one or more sector antenna, one or more of: increasing the selected transmission power for one of the one or more sector antenna, decreasing the selected transmission power for the one of the one or more sector antenna, or maintaining the selected transmission power for the one of the one or more sector antenna.

### PRIORITY CLAIM AND CROSS-REFERENCE

This application claims priority to Provisional Application No. 63/208,943, filed Jun. 9, 2021, which is hereby incorporated by reference in its entirety.

### BACKGROUND

A telecommunications network is a network of mobile devices (e.g., mobile phone and mobile computing devices) that communicate by radio waves through a local antenna at a cellular base station (e.g., cell tower). The coverage area in which service is provided is divided into small geographical areas called “cells”. Each cell is served by a separate low power multichannel transceiver and antenna at the cell tower. All mobile devices within a cell communicate through that cell's antenna on multiple frequencies and on separate frequency channels assigned by the base station from a common pool of frequencies used by the telecommunications network.

A ground station, Earth station, or Earth terminal is a terrestrial radio station designed for extra-planetary telecommunication with spacecraft, or reception of radio waves from astronomical radio sources. Ground stations communicate with spacecraft by transmitting and receiving radio waves in the super high frequency (SHF) or extremely high frequency (EHF) bands (e.g. microwaves). When a ground station successfully transmits radio waves to a spacecraft, the ground station establishes a telecommunications link. A part of the telecommunications device of the ground station is a parabolic antenna. A telecommunications port (e.g., teleport) is a satellite ground station that functions as a hub connecting a satellite or geocentric orbital network with a terrestrial telecommunications network. Teleports provide various broadcasting services among other telecommunications functions, such as uploading computer programs or issuing commands over an uplink to a satellite.

### BRIEF DESCRIPTION OF THE DRAWINGS

Aspects of the present disclosure are best understood from the following detailed description when read with the accompanying FIGS. It is noted that, in accordance with the standard practice in the industry, various features are not drawn to scale. In fact, the dimensions of the various features be arbitrarily increased or reduced for clarity of discussion.

FIG. 1 is a diagrammatic representation of a telecommunications network, in accordance with some embodiments.

FIG. 2A is a flow diagram representation of a method of increasing power transmission, in accordance with some embodiments.

FIG. 2B is a flow diagram representation of a method of decreasing power transmission, in accordance with some embodiments.

FIG. 3 is a flow diagram representation of a method of determining transmission power, in accordance with some embodiments.

FIG. 4 is a high-level functional block diagram of a processor-based system, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows include embodiments in which the first and second features are formed in direct contact, and also include embodiments in which additional features be formed between the first and second features, such that the first and second features not be in direct contact. In addition, the present disclosure repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, be used herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus be otherwise oriented (rotated 90 degrees or at other orientations) and the spatially relative descriptors used herein likewise be interpreted accordingly.

In some embodiments, a method for dynamically configuring a transmission power of a sector antenna in a telecommunications network is discussed. In some embodiments, the transmission power of a sector antenna is determined by the antenna's long-term and short-term interference. For example, a sector antenna uses high transmission power when interference is low and low power when inference is high.

In some approaches, a telecommunications network, such as a long-term evolution (LTE) network, determines the transmission power of an antenna by a coverage requirement (e.g., a large coverage area requires high power and a small coverage area only low power). In some embodiments, networks, such as 5G networks that use several different frequencies, that use high power in large coverage areas and small power in small coverage areas, like LTE networks, potentially cause co-channel interference. Additionally or alternatively, there is a possibility that the interference requirement of other systems sharing the same spectrum with the 5G network cannot be satisfied.

In some embodiments, the co-channel interference (e.g., long-term interference and short-term interference) is taken into account when determining the transmission power for a sector antenna and/or for a satellite ground station. In some embodiments, an antenna will use high transmission power if its short-term interference is low and low power if its long-term interference is high. In some embodiments, the 5G coverage is maximized while the interference requirements of other systems are satisfied.

In some embodiments, transmission power is configured for each antenna pursuant to interference limitations (e.g., long-term and short-term). Additionally or alternatively, short-term interference is the easier limitation to satisfy as short-term interference is a one-to-one interference. However, long-term interference is complicated to determine since long-term interference is a cumulative interference from all antennas. In some embodiments, a gap between a short-term interference threshold and a long-term interference threshold is determined. In some embodiments, this gap provides information on additional transmission power available to utilize without violating the long-term interference threshold that sets the bounds or upper limit on transmission power; thus maximizing coverage area. In some embodiments, therefore, a long-term budget is developed that indicates the average long-term interference threshold for each sector. Therefore, the cumulated long-term threshold is converted to an individual threshold. In some embodiments, this method is able to be used in any 5G system that has co-channel interference with other systems. In some embodiments, this method is particularly helpful when the transmission power has to be fixed prior to the antenna being installed and transmitting. For example, in Japan, the parameters of an antenna are not allowed to be changed after a 5G license is acquired.

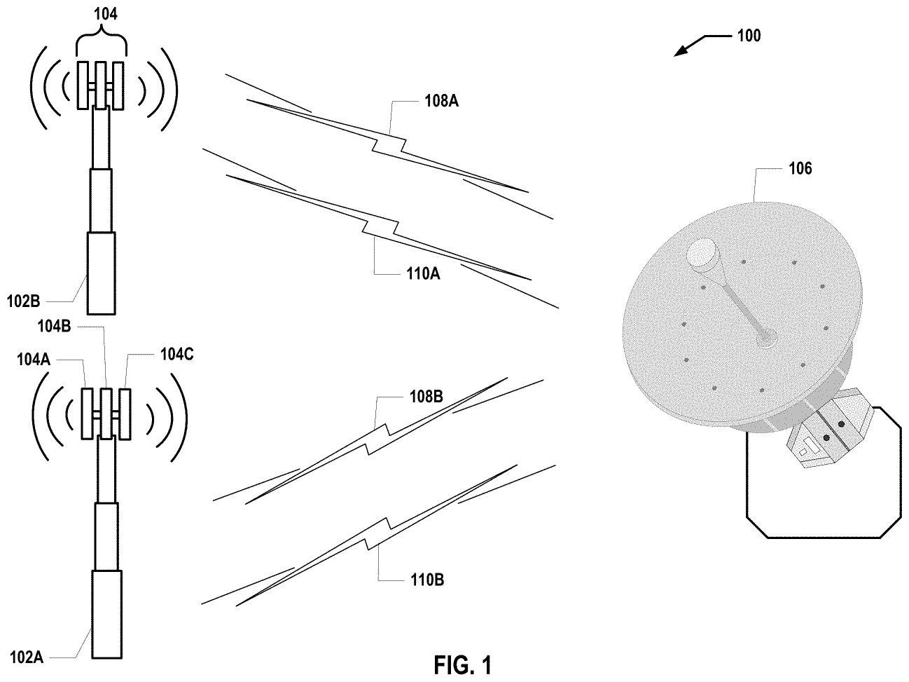

FIG. 1 is a diagrammatic representation of a telecommunications network 100, in accordance with some embodiments.

In some embodiments, telecommunications network 100 includes a set of sub-base stations 102A and 102B (hereinafter referred to as set of sub-base stations 102 or sub-base station 102). In some embodiments, each sub-base station 102 includes a set of sector antennas 104A, 104B and 104C (herein after referred to as set of sector antennas 104 or sector antenna 104), typically in groups of three, near the top of sub-base stations 102. In some embodiments, set of sector antennas 104 communicate with one or more satellite ground stations 106.

In some embodiments, telecommunications network 100 is a group of nodes interconnected by links that are used to exchange messages between the nodes. The links use a variety of technologies, such as 5G, based on the methodologies of circuit switching, message switching, or packet switching, to pass messages and signals. Multiple nodes cooperate to pass the message from an originating node to the destination node, via multiple network hops. For this routing function, each node in the network is assigned a network address for identification and locating the node on the network. The collection of addresses in the network is called the address space of the network. Examples of telecommunications networks include computer networks, the Internet, the public switched telephone network (PSTN), the global Telex network, the aeronautical ACARS network, and the wireless radio networks of cell phone telecommunication providers.

In telecommunications, 5G is the fifth generation technology standard for broadband cellular networks and is the planned successor to the 4G networks which provide connectivity to most current cellphones. 5G networks are cellular networks, in which the service area is divided into small geographical areas called cells. All 5G wireless devices in a cell are connected to the Internet and telephone network by radio waves through a local antenna, such as one of antennas 104, in the cell. 5G networks have greater bandwidth giving higher download speeds up to 10 gigabits per second (Gbit/s). Due to the increased bandwidth, networks are expected to be used increasingly as general internet service providers for laptops and desktop computers and also will make possible new applications in internet of things (IoT) and machine to machine areas.

The increased speed of 5G networks, such as network 100, is achieved by using additional higher-frequency radio waves in addition to the low and medium band frequencies used in previous cellular networks. However, higher-frequency radio waves have a shorter useful physical range, requiring smaller geographic cells. For wide service, 5G networks operate on up to three frequency bands—low, medium, and high. A 5G network is composed of networks including up to three different types of cells, each utilizing specific antenna designs as well as providing a different tradeoff of download speed to distance and service area.

In at least one embodiment, set of sub-base stations 102 is able to be lattice or self-support towers, guyed towers, monopole towers, and concealed towers (e.g., towers designed to resemble trees, cacti, water towers, signs, light standards, and other types of structures). Additionally or alternatively, set of sub-base stations 102 is a cellular-enabled mobile device site where antennas and electronic communications equipment are placed, for example on a radio mast, tower, or other raised structure to create a cell (or adjacent cells) in a network. The raised structure typically supports antenna(s) 104 and one or more sets of transmitter/receivers transceivers, digital signal processors, control electronics, a global positioning system (GPS) receiver for timing, primary and backup electrical power sources, and sheltering. Set of sub-base stations 102 are known by other names such as base transceiver station, mobile phone mast, or base station.

In at least one embodiment, set of sector antenna(s) 104 includes sector antennas. Additionally or alternatively, set of sector antenna(s) 104 is a type of directional microwave antenna with a sector-shaped radiation pattern. In at least one embodiment, the sector degrees of arc are 60°, 90° or 120° designs with a few degrees variations to help ensure overlap. Additionally or alternatively, the azimuth of the sector antennas are designed to avoid overlap. Further, sector antennas are mounted in multiples when wider coverage or a full-circle coverage is desired. In at least one embodiment, set of sector antenna(s) 104 is a rectangular antenna, sometimes called a panel antenna or radio antenna, used to transmit and receive waves or data between mobile devices or other devices and a sub-base station. Additionally or alternatively, set of sector antenna(s) 104 includes circular antennas. In at least one embodiment, set of sector antenna(s) 104 operates at microwave or ultra-high frequency (UHF) frequencies. In some examples, set of sector antenna(s) 104 are chosen for based on size and directional properties.

In some embodiments, satellite ground station 106 is a satellite ground station that functions as a hub connecting a satellite or geocentric orbital network with a terrestrial telecommunications network, such as network 100. In some embodiments, satellite ground state 106 provides various broadcasting services among other telecommunications functions, such as uploading computer programs or issuing commands over an uplink to a satellite. In Federal Standard 1037C, the United States General Services Administration defined an Earth terminal complex as the assemblage of equipment and facilities necessary to integrate an Earth terminal (ground station) into a telecommunications network. FS-1037C has since been subsumed by the ATIS Telecom Glossary, which is maintained by the Alliance for Telecommunications Industry Solutions (ATIS), an international, business-oriented, non-governmental organization. The Telecommunications Industry Association also acknowledges this definition.

In FIG. 1, long-term interference 108A and 108B occurs in communication between set of sector antennas 104 and satellite ground station 106. Additionally or alternatively, short-term interference 110A and 110B occurs in communication between set of sector antennas 104 and satellite ground station 106. In some embodiments, satellite ground station 106 has two thresholds: a long-term threshold and a short-term threshold. As discussed before the long-term threshold is cumulative. In some embodiments, the sum of all long-term interference 108A and 108B (including any other long-term interference as well, even long-term interference not associated with network 100) is below a long-term threshold. However, in contrast, short-term interference 110A or 110B individually are below a short-term interference threshold.

In some embodiments, mathematically, a short-term threshold is where the total time interference is greater than the short-term threshold of 5 minutes over one year (e.g., about 0.001% of the year). Additionally or alternatively, a long-term threshold is where the total time interference is greater than the long-term threshold of 73 days a year (e.g., about 20% of the year). In some embodiments, a solution to reduce or avoid the short-term and long-term thresholds is to provide for a dynamic power transmission configuration.

In some embodiments, the co-channel interference (e.g., both long-term and short-term interference) is taken into account when configuring the transmission power. Additionally or alternatively, sector antennas 104 transmit at a high power if the co-channel interference is low and at a lower power if the co-channel interference is high. In some embodiments, the 5G coverage is maximized while the interference thresholds of other systems are satisfied. As 5G uses multiple frequencies some of these frequencies overlap with non 5G systems and this overlap causes interference. In some embodiments, interference is constant and if the interference is greater than a short or long-term threshold, then the corresponding sector is abandoned. Additionally or alternatively, abandoning a sector means a sector antenna is not built in the location determined to have a greater interference than a short or long-term threshold.

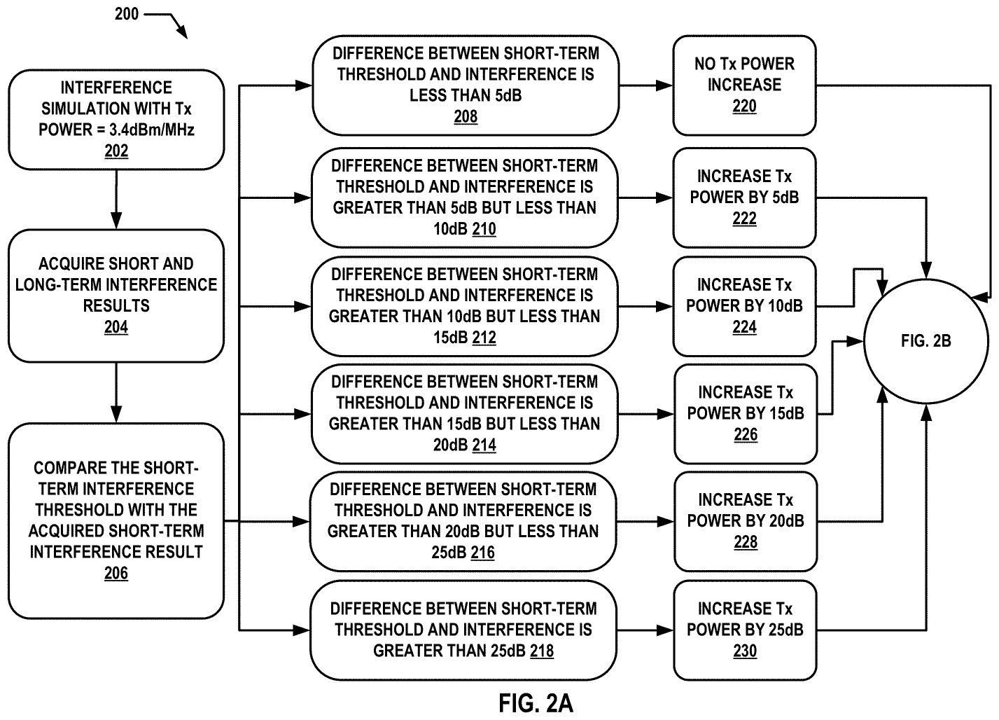

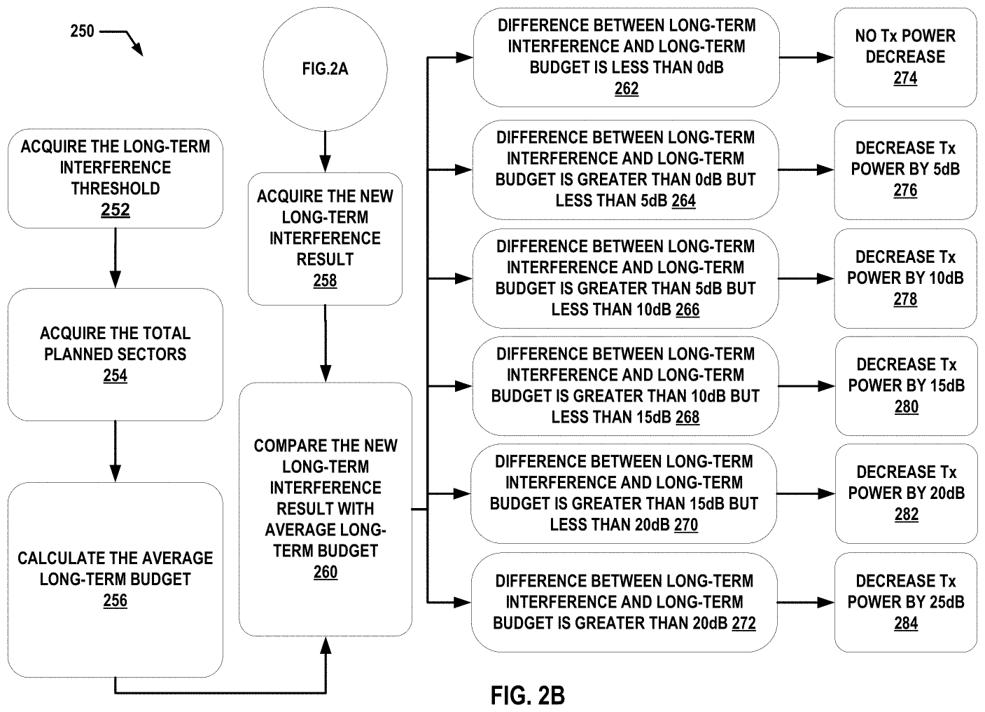

In some embodiments, discussed in detail in FIGS. 2A and 2B a dynamic power transmission method configures the transmission power for each sector antenna 104 according to short-term and long-term interference.

FIG. 2A is a flow diagram representation of a method 200 of increasing power transmission, in accordance with some embodiments.

In some embodiments, method 200 is used to determine power transmission for sector-antenna 104 of network 100. Additionally or alternatively, method 200 is an operation to increase the transmission power of a sector antenna based on a gap between short-term interference and the short-term interference threshold. The sequence in which the operations of method 200 are depicted in FIG. 2A is for illustration only; the operations of method 200 are capable of being executed in sequences that differ from that depicted in FIG. 2A. In some embodiments, operations in addition to those depicted in FIG. 2A are performed before, between, during, and/or after the operations depicted in FIG. 2A.

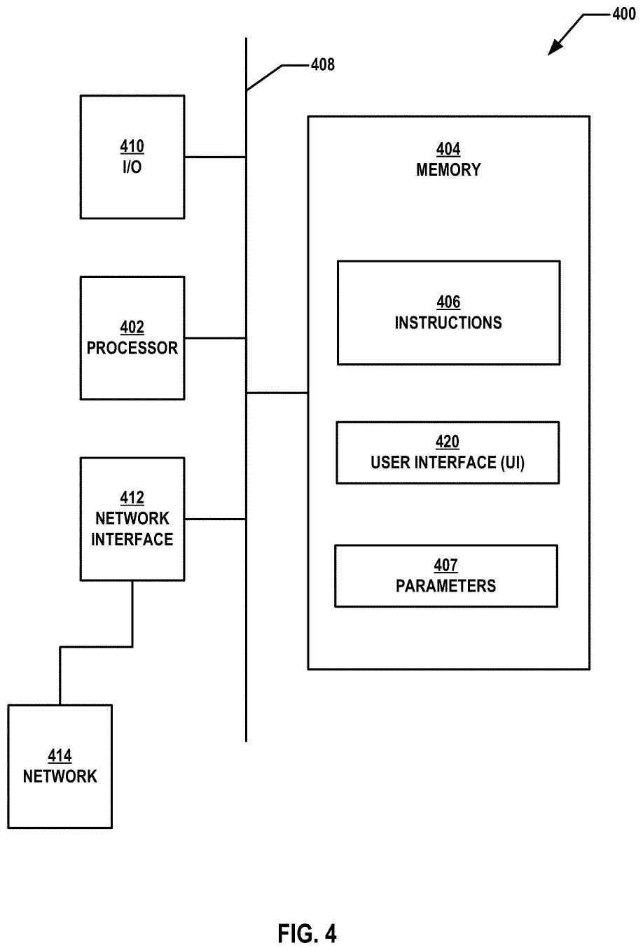

In some embodiments, one or more of the operations of method 200 are a subset of operations of a method of configuring transmission power. In some embodiments, one or more of the operations of method 200 are a subset of operations of a method of configuring transmission power. In various embodiments, one or more of the operations of method 200 are performed by using one or more processors, e.g., a processor 402 discussed below with respect to dynamic power transmission processing circuitry 400 and FIG. 4.

In some embodiments, at operation 202 of method 200 an interference simulation is performed. Additionally or alternatively, the simulation is performed in a simulated location for the sector antenna and the transmission power is set; for example the initial transmission power is set at 3.4 dBm/MHz. In some embodiments, the initial transmission power is not set at 3.4 dBm/MHz, but instead is any value as long as the antenna hardware, such as sector antenna 104, supports the transmission power. Method 200 progresses to operation 204 where the short and long-term interference results are obtained from the simulation performed at operation 202.

In some embodiments, at operation 206 of method 200 a short-term interference threshold is compared with the acquired short-term interference result of operation 204. In some embodiments, the short-term threshold is predefined by owners of satellite ground stations, such as satellite ground station 106. In some embodiments, the short-term and long-term interference threshold are provided by a manufacturer of a sector antenna. In 5G communications systems, there is interference with the satellite ground station, such as satellite ground station 106. In some embodiments, the satellite ground station owners will provide the short-term and long-term interference thresholds. In some embodiments, the short-term and long-term thresholds do not change overtime. When the difference between the short-term threshold and the short-term interference is less than 5 dB (operation 208) the transmission power of the sector antenna is not increased (operation 220). Thus, the short-term interference, as simulated, is already at or near the short-term threshold. In some embodiments, the difference between the short-term threshold and the short-term interference that determines no transmission power increase (such as 5 dB at operation 208) is determined by antenna hardware. For example, when the antenna hardware support a power change operation of 0.1 dB, then the difference determination difference between the short-term threshold and the short-term interference as well as the power increases at operations 222, 224, 226, 228 and 230 are performed in increments of 0.1 dB instead of 5 dB as shown in FIG. 2A and discussed in the present disclosure.

When the difference between the short-term threshold and the short-term interference is greater than 5 dB but less than 10 dB (operation 210) (also related to the sector antenna power change step discussed above; e.g., increments of 0.1 dB) the transmission power of the sector antenna is increased by 5 dB (operation 222). When the difference between the short-term threshold and the short-term interference is greater than 10 db but less than 15 dB (operation 212) (also related to the sector antenna power change step discussed above; e.g., increments of 0.1 dB) the transmission power of the sector antenna is increased by 10 dB (operation 224). When the difference between the short-term threshold and the short-term interference is greater than 15 dB but less than 20 dB (operation 214) (also related to the sector antenna power change step discussed above; e.g., increments of 0.1 dB) the transmission power of the sector antenna is increased by 15 dB (operation 226). When the difference between the short-term threshold and the short-term interference is greater than 20 dB but less than 25 dB (operation 216) (also related to the sector antenna power change step discussed above; e.g., increments of 0.1 dB) the transmission power of the sector antenna is increased by 20 dB (operation 228). When the difference between the short-term threshold and the short-term interference is greater than 25 dB (operation 218) the transmission power of the sector antenna is increased by 25 dB (operation 230).

In some embodiments, method 200 will increase the transmission power proportionately to the difference between the short-term threshold and the short-term interference. Additionally or alternatively, the sector antenna will use the highest transmission power possible to help ensure a greater coverage area. In some embodiments, the transmission power is increased up to the short-term interference threshold to maximize transmission power and thus antenna coverage.

FIG. 2B is a flow diagram representation of a method 250 of decreasing power transmission, in accordance with some embodiments.

In some embodiments, method 250 is used to determine power transmission for sector-antenna 104 of network 100. The sequence in which the operations of method 250 are depicted in FIG. 2b is for illustration only; the operations of method 250 are capable of being executed in sequences that differ from that depicted in FIG. 2B. In some embodiments, operations in addition to those depicted in FIG. 2B are performed before, between, during, and/or after the operations depicted in FIG. 2B.

In some embodiments, one or more of the operations of method 250 are a subset of operations of a method of configuring transmission power. In some embodiments, one or more of the operations of method 250 are a subset of operations of a method of configuring transmission power. In various embodiments, one or more of the operations of method 250 are performed by using one or more processors, e.g., a processor 402 discussed below with respect to dynamic power transmission processing circuitry 400 and FIG. 4.

In some embodiments, at operation 252 method 250 acquires the long-term interference threshold from the satellite ground station owner, as long-term interference threshold is predefined as discussed above, and is acquired from the satellite ground station owner. From operation 252, method 250 progresses to operation 254 where method 250 determines the total planned sectors. In some embodiments, the total planned sectors is inputted by a user or method 250 inputs the total planned sectors based upon previously inputted planned sector locations. For example, based on FIG. 1, where each sub-base station 102 has three sectors (e.g., three sector antennas 104A, 104B and 104C) and there are two sub-base stations 102, then there are 6 total sectors. In some embodiments, all sectors are taken into account as long-term interference is cumulative and thus all sectors are accounted for.

In some embodiments, method 250 progresses to operation 256 where an average long-term budget for each sector is determined. In some embodiments, the average long-term budget is determined by dividing the long-term threshold by the total number of planned sectors. Thus, since long-term interference is cumulative, the long-term threshold for the set of sector antenna is divided equally amongst each of the sector antennas. In some embodiments, this is the long-term budget, or allowable long-term interference, for each sector.

In some embodiments, method 250 at operation 258 acquires the long-term interference result from the stimulation at operation 204 of method 200. Method 250 progresses to operation 260 where the long-term budget is compared with the simulated long-term interference result. When the difference between the long-term budget and the long-term interference is less than 0 dB (operation 262) the transmission power of the sector antenna is not decreased from method 200 (operation 274). Thus, in some embodiments, the transmission power set in method 200 for the short-term interference will be the transmission power for the sector antenna when it is placed and installed (e.g., no modifications to transmission power due to long-term interference need to be made).

When the difference between the long-term budget and the long-term interference is greater than 0 dB but less than 5 dB (operation 264) the transmission power of the sector antenna is decreased by 5 dB (operation 276). When the difference between the long-term budget and the long-term interference is greater than 5 dB but less than 10 dB (operation 266) the transmission power of the sector antenna is decreased by 10 dB (operation 278). When the difference between the long-term budget and the long-term interference is greater than 10 dB but less than 15 dB (operation 268) the transmission power of the sector antenna is decreased by 15 dB (operation 280). When the difference between the long-term budget and the long-term interference is greater than 15 dB but less than 20 dB (operation 270) the transmission power of the sector antenna is decreased by 20 dB (operation 282). When the difference between the long-term budget and the long-term interference is greater than 20 dB (operation 272) the transmission power of the sector antenna is decreased by 25 dB (operation 284).

In some embodiments, the decreasing of the power transmitted ensures no violations of the long-term interference threshold. Additionally or alternatively, once the power transmission value is determined, the sector antenna is ready for installation and will not have to be adjusted once installed. In some embodiments, a balance is obtained between high power transmission for greater coverage (but possible long-term interference issues) and low power transmission for lower coverage (but avoiding long-term interference issues).

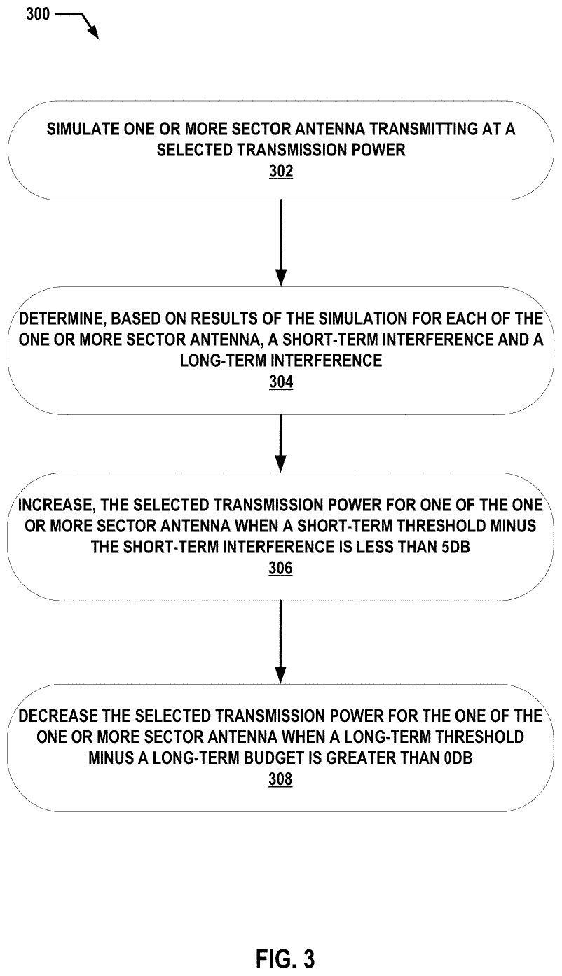

FIG. 3 is a flow diagram representation of a method 300 of determining transmission power, in accordance with some embodiments.

In some embodiments, method 300 is used to determine power transmission for sector-antenna 104 of network 100. The sequence in which the operations of method 300 are depicted in FIG. 3 is for illustration only; the operations of method 300 are capable of being executed in sequences that differ from that depicted in FIG. 3. In some embodiments, operations in addition to those depicted in FIG. 3 are performed before, between, during, and/or after the operations depicted in FIG. 3.

In some embodiments, one or more of the operations of method 300 are a subset of operations of a method of configuring transmission power. In some embodiments, one or more of the operations of method 300 are a subset of operations of a method of configuring transmission power. In various embodiments, one or more of the operations of method 300 are performed by using one or more processors, e.g., a processor 402 discussed below with respect to dynamic power transmission processing circuitry 400 and FIG. 4.

At block 302 of method 300, a simulation is performed on one or more sector antenna transmitting at a selected transmission power. In addition, each of the one or more sector antenna are simulated as being located at a desired physical location. As a non-limiting example, in the embodiments as shown in FIGS. 1, 2A and 2B a sector antenna 104 is simulated in the location where it is desired to place the sector antenna. Continuing the example, at operation 202 of method 200, sector antenna 104 are simulated as being a desired fixed location and transmitting at a power. From block 302, flow proceeds to block 304.

At block 304 of method 300, based on results of the simulation, a short-term interference and a long-term interference are determined. In addition, a short-term and long-term interference are determined for each of the one or more sector antenna are simulated as being located at a desired physical location. As a non-limiting example, in the embodiments as shown in FIGS. 1, 2A and 2B a short-term and long-term interference for a desired location is determined based upon known transmissions for the desired location. Continuing the example, at operation 204 of method 200, dynamic power transmission processing circuitry 400 obtains the short and long-term interference results from the simulation. From block 304, flow proceeds to block 306.

At block 306 of method 300, based on a short-term interference threshold, increasing the selected transmission power for one of the one or more sector antenna. As a non-limiting example, in the embodiments as shown in FIG. 2A transmission power is held constant or increased for the sector antenna based upon the difference between the short-term threshold and the simulated short-term interference. Continuing the example, at operations 208-218 of method 200, transmission power is increased to maximize sector antenna coverage based upon how much transmission power is used before a violation of short-term interference occurs. From block 306, flow proceeds to block 308.

At block 308 of method 300, based on a long-term interference threshold, decreasing the selected transmission power for one of the one or more sector antenna. As a non-limiting example, in the embodiments as shown in FIG. 2B transmission power is held constant or decreased for the sector antenna based upon the difference between the long-term interference and the long-term interference budget. Continuing the example, at operations 262-272 of method 250, transmission power is held constant or decreased to maximize sector antenna coverage based upon how much transmission power is used before a violation of long-term interference occurs.

FIG. 4 is a block diagram of dynamic power transmission processing circuitry 400 in accordance with some embodiments. In some embodiments, dynamic power transmission processing circuitry 400 is a general purpose computing device including a hardware processor 402 and a non-transitory, computer-readable storage medium 404. Storage medium 404, amongst other things, is encoded with, i.e., stores, computer program code 406, i.e., a set of executable instructions such as cell antenna outage compensation algorithm. Execution of instructions 406 by hardware processor 402 represents (at least in part) a neighboring cell/antenna discovery tool which implements a portion or all of the methods described herein in accordance with one or more embodiments (hereinafter, the noted processes and/or methods).

Processor 402 is electrically coupled to a computer-readable storage medium 404 via a bus 408. Processor 402 is also be electrically coupled to an I/O interface 410 by bus 408. A network interface 412 is also electrically connected to processor 402 via bus 408. Network interface 412 is connected to a network 414, so that processor 402 and computer-readable storage medium 404 are capable of connecting to external elements via network 414. Processor 402 is configured to execute computer program code 406 encoded in computer-readable storage medium 404 in order to cause coverage hold dynamic power transmission processing circuitry 400 to be usable for performing a portion or all of the noted processes and/or methods, such as methods 200, 250, and 300 or FIGS. 2A, 2B, and 3. In one or more embodiments, processor 402 is a central processing unit (CPU), a multi-processor, a distributed processing system, an application specific integrated circuit (ASIC), and/or a suitable processing unit.

In one or more embodiments, computer-readable storage medium 404 is an electronic, magnetic, optical, electromagnetic, infrared, and/or a semiconductor system (or apparatus or device). For example, computer-readable storage medium 404 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 404 includes a compact disk-read only memory (CD-ROM), a compact disk-read/write (CD-R/W), and/or a digital video disc (DVD).

In one or more embodiments, storage medium 404 stores computer program code 406 configured to cause dynamic power transmission processing circuitry 400 to be usable for performing a portion or all of the noted processes and/or methods. In one or more embodiments, storage medium 404 also stores information, such as dynamic power transmission algorithm which facilitates performing a portion or all of the noted processes and/or methods. In one or more embodiments, storage medium 404 stores parameters 407.

Dynamic power transmission processing circuitry 400 includes I/O interface 410. I/O interface 410 is coupled to external circuitry. In one or more embodiments, I/O interface 410 includes a keyboard, keypad, mouse, trackball, trackpad, touchscreen, and/or cursor direction keys for communicating information and commands to processor 402.

Dynamic power transmission processing circuitry 400 is also include network interface 412 coupled to processor 402. Network interface 412 allows dynamic power transmission processing circuitry 400 to communicate with network 414, to which one or more other computer systems are connected. Network interface 412 includes wireless network interfaces such as BLUETOOTH, WIFI, WIMAX, GPRS, or WCDMA; or wired network interfaces such as ETHERNET, USB, or IEEE-864. In one or more embodiments, a portion or all of noted processes and/or methods, is implemented in two or more dynamic power transmission processing circuitry 400.

Dynamic power transmission processing circuitry 400 is configured to receive information through I/O interface 410. The information received through I/O interface 410 includes one or more of instructions, data, and/or other parameters for processing by processor 402. The information is transferred to processor 402 via bus 408. Dynamic power transmission processing circuitry 400 is configured to receive information related to a UI through I/O interface 410. The information is stored in computer-readable medium 404 as user interface (UI) 420.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application.

In some embodiments, the processes are realized as functions of a program stored in a non-transitory computer readable recording medium. Examples of a non-transitory computer-readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

A system of one or more computers are configured to perform particular operations or actions by virtue of having software, firmware, hardware, or a combination of them installed on the system that in operation causes or cause the system to perform the actions. One or more computer programs are configured to perform particular operations or actions by virtue of including instructions that, when executed by data processing apparatus, cause the apparatus to perform the actions. In some embodiments, a method includes simulating, using processing circuitry, one or more sector antenna transmitting at a selected transmission power, each of the one or more sector antenna simulated as being located at a desired physical location. The method also includes determining, based on results of the simulation, a short-term interference and a long-term interference for each of the one or more sector antenna. The method also includes performing, by the processing circuitry and based on a short-term interference threshold and a long-term interference threshold for the one or more sector antenna, one or more of: increasing the selected transmission power for one of the one or more sector antenna, decreasing the selected transmission power for the one of the one or more sector antenna, or maintaining the selected transmission power for the one of the one or more sector antenna. Other embodiments of this aspect include corresponding computer systems, apparatus, and computer programs recorded on one or more computer storage devices, each configured to perform the actions of the methods.

Implementations may include one or more of the following features. The method where the increasing the selected transmission power for the one of the one or more sector antenna includes: determining, using the processing circuitry, whether a difference between a short-term threshold and the short-term interference is greater than 5 dB; and increasing, using the processing circuitry, the selected transmission power by at least 5 dB in response to the difference between the short-term threshold and the short-term interference being greater than 5 dB. The decreasing the selected transmission power for the one of the one or more sector antenna includes: determining, using the processing circuitry, whether a difference between the long-term interference and a long-term budget is greater than 0 dB; and decreasing, using the processing circuitry, the selected transmission power by at least 5 dB in response to the difference between the long-term interference and the long-term budget being greater than 0 dB. The method includes setting the long-term budget by dividing the long-term interference threshold by a number of the one or more sector antenna that are to be deployed at the desired physical location. The maintaining the selected transmission power for the one or the one or more sector antenna further includes: determining, using the processing circuitry, whether a difference between a short-term threshold and the short-term interference is less than 5 dB; and determining, using the processing circuitry, whether a difference between the long-term interference and a long-term budget is less than 0 dB. The method includes: setting, using the processing circuitry and based upon a short-term threshold and a long-term budget, a pre-set transmission power for the one of the one or more sector antenna prior to installing the one of the one or more sector antenna. Implementations of the described techniques may include hardware, a method or process, or computer software on a computer-accessible medium.

In some embodiments, a method includes simulating, using processing circuitry, one or more sector antenna transmitting at a selected transmission power, each of the one or more sector antenna simulated as being located at a desired physical location. The method also includes determining, based on results of the simulation for each of the one or more sector antenna, a short-term interference and a long-term interference. The method also includes increasing, using the processing circuitry, the selected transmission power for one of the one or more sector antenna in response to a difference between a short-term threshold and the short-term interference is less than 5 dB. The method also includes decreasing, using the processing circuitry, the selected transmission power for the one of the one or more sector antenna in response to a difference between the long-term interference and a long-term budget is greater than 0 dB. Other embodiments of this aspect include corresponding computer systems, apparatus, and computer programs recorded on one or more computer storage devices, each configured to perform the actions of the methods.

Implementations may include one or more of the following features. The method includes maintaining the selected transmission power for the one of the one or more sector antenna in response to the difference between the short-term threshold and the short-term interference is less than 5 dB and in response to the difference between the long-term interference and the long-term budget is less than 0 dB. The increasing the selected transmission power for the one of the one or more sector antenna includes: increasing, using the processing circuitry, the selected transmission power by an amount substantially equal to the difference between the short-term threshold and the short-term interference. The decreasing the selected transmission power for the one of the one or more sector antenna includes: decreasing, using the processing circuitry, the selected transmission power by an amount substantially equal to the difference between the long-term interference and the long-term budget. The long-term budget is a pre-determined long-term interference threshold divided by a number of the one or more sector antenna that are to be deployed at the desired physical location. The method includes: setting, using the processing circuitry and based upon the short-term threshold and the long-term budget, a pre-set transmission power for the one of the one or more sector antenna before the one of the one or more sector antenna is installed in a pre-planned location. The method includes: repeating, using the processing circuitry, the increasing and decreasing of the selected transmission power until one of the following occur: where the difference between the short-term threshold and the short-term interference is less than 5 dB; or where the difference between the long-term interference minus the long-term budget is less than 0 dB. Implementations of the described techniques may include hardware, a method or process, or computer software on a computer-accessible medium.

In some embodiments, a system includes processing circuitry and a memory connected to the processing circuitry, where the memory is configured to store executable instructions that, when executed by the processing circuitry, facilitate performance of operations, includes. The system also includes simulating, using the processing circuitry, one or more sector antenna transmitting at a selected transmission power, each of the one or more sector antenna simulated as being located at a desired physical location. The system also includes determining, based on results of the simulation for each of the one or more sector antenna, a short-term interference and a long-term interference. The system also includes increasing, using the processing circuitry, the selected transmission power for one of the one or more sector antenna in response to a difference between a short-term threshold and the short-term interference is less than 5 dB. The system also includes decreasing, using the processing circuitry, the selected transmission power for the one of the one or more sector antenna in response to a difference between the long-term interference and a long-term budget is greater than 0 dB. Other embodiments of this aspect include corresponding computer systems, apparatus, and computer programs recorded on one or more computer storage devices, each configured to perform the actions of the methods.

Implementations may include one or more of the following features. The system where the one or more of the sector antenna are capable of transmitting and receiving in a telecommunications system. The one or more sector antenna are used in a 5g telecommunications system. The one or more sector antenna is installed in a pre-planned location. The performance of operations, further includes: decreasing, using the processing circuitry, the selected transmission power by an amount substantially equal to the difference between the long-term interference and the long-term budget. The long-term budget is a pre-determined long-term interference threshold divided by a number of the one or more sector antenna that are to be deployed at the desired physical location. Implementations of the described techniques may include hardware, a method or process, or computer software on a computer-accessible medium.

The foregoing outlines features of several embodiments so that those skilled in the art better understand the aspects of the present disclosure. Those skilled in the art should appreciate that they readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they make various changes, substitutions, and alterations herein without departing from the spirit and scope of the present disclosure.

What is claimed is:

1. A method, comprising:
simulating, using processing circuitry, one or more sector antenna transmitting at a selected transmission power, each of the one or more sector antenna simulated as being located at a physical location;
determining, based on results of the simulation, a short-term interference and a long-term interference for each of the one or more sector antenna; and
performing, by the processing circuitry and based on a short-term interference threshold and a long-term interference threshold for the one or more sector antenna, one or more of:
increasing the selected transmission power for one of the one or more sector antenna;
decreasing the selected transmission power for the one of the one or more sector antenna; or
maintaining the selected transmission power for the one of the one or more sector antenna.

2. The method of claim 1, wherein the increasing the selected transmission power for the one of the one or more sector antenna comprises:
determining, using the processing circuitry, whether a difference between a short-term threshold and the short-term interference is greater than 5 dB; and
increasing, using the processing circuitry, the selected transmission power by at least 5 dB in response to the difference between the short-term threshold and the short-term interference being greater than 5 dB.

3. The method of claim 1 wherein the decreasing the selected transmission power for the one of the one or more sector antenna comprises:
determining, using the processing circuitry, whether a difference between the long-term interference and a long-term budget is greater than 0 dB; and
decreasing, using the processing circuitry, the selected transmission power by at least 5 dB in response to the difference between the long-term interference and the long-term budget being greater than 0 dB.

4. The method of claim 3, further comprising setting the long-term budget by dividing the long-term interference threshold by a number of the one or more sector antenna that are to be deployed at the physical location.

5. The method of claim 1 wherein the maintaining the selected transmission power for the one or the one or more sector antenna further comprises:
determining, using the processing circuitry, whether a difference between a short-term threshold and the short-term interference is less than 5 dB; and
determining, using the processing circuitry, whether a difference between the long-term interference and a long-term budget is less than 0 dB.

6. The method of claim 1 further comprising:
setting, using the processing circuitry and based upon a short-term threshold and a long-term budget, a pre-set transmission power for the one of the one or more sector antenna prior to installing the one of the one or more sector antenna.

7. A method, comprising:
simulating, using processing circuitry, one or more sector antenna transmitting at a selected transmission power, each of the one or more sector antenna simulated as being located at a physical location;
determining, based on results of the simulation for each of the one or more sector antenna, a short-term interference and a long-term interference;
increasing, using the processing circuitry, the selected transmission power for one of the one or more sector antenna in response to a difference between a short-term threshold and the short-term interference being less than 5 dB; and
decreasing, using the processing circuitry, the selected transmission power for the one of the one or more sector antenna in response to a difference between the long-term interference and a long-term budget is greater than 0 dB.

8. The method of claim 7, further comprising maintaining the selected transmission power for the one of the one or more sector antenna in response to the difference between the short-term threshold and the short-term interference being less than 5 dB and in response to the difference between the long-term interference and the long-term budget being less than 0 dB.

9. The method of claim 7 wherein the increasing the selected transmission power for the one of the one or more sector antenna comprises:
increasing, using the processing circuitry, the selected transmission power by an amount substantially equal to the difference between the short-term threshold and the short-term interference.

10. The method of claim 7 wherein the decreasing the selected transmission power for the one of the one or more sector antenna comprises:
decreasing, using the processing circuitry, the selected transmission power by an amount substantially equal to the difference between the long-term interference and the long-term budget.

11. The method of claim 10 wherein the long-term budget is a pre-determined long-term interference threshold divided by a number of the one or more sector antenna that are to be deployed at the physical location.

12. The method of claim 7 further comprising:
setting, using the processing circuitry and based upon the short-term threshold and the long-term budget, a pre-set transmission power for the one of the one or more sector antenna before the one of the one or more sector antenna is installed in a pre-planned location.

13. The method of claim 7 further comprising:
repeating, using the processing circuitry, the increasing and decreasing of the selected transmission power until one of the following occurs:
where the difference between the short-term threshold and the short-term interference is less than 5 dB; or
where the difference between the long-term interference and the long-term budget is less than 0 dB.

14. A system, comprising:
processing circuitry; and
a memory connected to the processing circuitry, wherein the memory is configured to store executable instructions that, when executed by the processing circuitry, facilitate performance of operations, comprising:
simulating, using the processing circuitry, one or more sector antenna transmitting at a selected transmission power, each of the one or more sector antenna simulated as being located at a physical location;
determining, based on results of the simulation for each of the one or more sector antenna, a short-term interference and a long-term interference;
increasing, using the processing circuitry, the selected transmission power for one of the one or more sector antenna in response to a difference between a short-term threshold and the short-term interference being less than 5 dB; and
decreasing, using the processing circuitry, the selected transmission power for the one of the one or more sector antenna in response to a difference between the long-term interference and a long-term budget being greater than 0 dB.

15. The system of claim 14 wherein the one or more of the sector antenna are capable of transmitting and receiving in a telecommunications system.

16. The system of claim 14 wherein the one or more sector antenna are usable in a 5G telecommunications system.

17. The system of claim 16 wherein the one or more sector antenna is installed in a pre-planned location.

18. The system of claim 14 wherein the performance of operations, further comprises:
decreasing, using the processing circuitry, the selected transmission power by an amount substantially equal to the difference between the long-term interference and the long-term budget.

19. The system of claim 18 wherein the long-term budget is a pre-determined long-term interference threshold divided by a number of the one or more sector antenna that are to be deployed at the desired physical location.

20. The system of claim 14 wherein the performance of operations, further comprises:
setting, using the processing circuitry and based upon the short-term threshold and the long-term budget, a pre-set transmission power for the one of the one or more sector antenna before the one of the one or more sector antenna is installed in a pre-planned location.
